(19) United States
(12) Patent Application Publication
(10) Pub. No.: US 2015/0368051 A1
(43) Pub. Date: Dec. 24, 2015

(54) Flue Gas Treatment Process

(71) Applicant: Natronx Technologies, LLC, Princeton, NJ (US)

(72) Inventors: William Copenhafer, Yardley, PA (US); Gerald Niedringhaus, Rock Springs, WY (US); Aaron Reichl, Green River, WY (US)

(21) Appl. No.: 14/307,538

(22) Filed: Jun. 18, 2014

(51) Int. Cl. B65G 53/00

(52) U.S. Cl. CPC B65G 53/00

(57) ABSTRACT

An improved process is disclosed for conveying trona powder to be used in treating flue gas to remove impurities from the flue gas. The trona powder is pneumatically conveyed under controlled conditions wherein
a. the temperature of the conveying air is maintained at less than 135 degrees F., preferably less than 130 degrees F.,
b. the relative humidity of the conveying air is maintained between about 15% and 50% and
c. the dew point of the conveying air is maintained above the temperature of both the conveying lines and the receiving vessels

### FIELD OF THE INVENTION

The present invention relates to a process for the treatment of flue gases to remove impurities present in such gases. In particular the invention relates to a process in which trona powder is employed to reduce the emission of acid gases; more specifically to a process in which conditioned air is used to transport the trona powder prior to introduction into the flue gas.

### BACKGROUND OF THE INVENTION

Trona is a naturally occurring mineral containing sodium sesquicarbonate (Na₂CO₃.NaHCO₃.2H₂O). A vast underground deposit of trona exists in southwestern Wyoming. Trona ore is typically extracted using mechanical mining methods, such as longwall mining equipment or boring machines. The ore as mined often contains approximately 10-15% shale impurities along with the sodium sesquicarbonate. Trona ore is hoisted to the surface where it is processed into various commercial alkali products including beneficiated trona, recrystallized sodium sesquicarbonate, sodium bicarbonate and soda ash. Sized, beneficiated and dried trona generally is sold in the form of either a powder or a granule. Granular trona is a relatively free-flowing product that goes into several markets, such as animal feed.

Most of the trona powder product is used in flue gas treatment applications at electric utilities, incinerators and industrial plants that employ trona to reduce emissions of acid gases, such as SO₂, SO₃, HCl and HF. The trona powder product typically has a median particle size of less than 50 microns and often less than 35 microns. For acid gas treatment applications, trona powder is blown with air into a flue gas duct in a process known as Dry Sorbent Injection (DSI). When trona is introduced into hot flue gases (typically greater than about 275° F.), it calcines to a porous sodium carbonate (soda ash) that has favorable physical properties for reacting with acid gases. The overall calcination reaction to soda ash is as follows:

2Na₂CO₃.NaHCO₃.2H₂O+heat→3Na₂CO₃+5H₂O (equation 1)

The fine particle size distribution of the trona powder contributes to the relatively poor flow properties of the material. Deterioration of the already poor flow properties can occur if the trona powder is exposed to excessive heat or allowed to come into contact with moist air. Therefore, steps are taken during material handling operations to protect the integrity of the trona powder. For example, trona powder is generally shipped and delivered to customers in pressure differential (PD) bulk railcars or trucks.

A blower, fan or compressor typically provides the conveying air for unloading trona powder from PD rail cars or PD trucks. Heat generated in compressing the air can result in temperatures in excess of 200° F. The conveying air from the transport air blower is desirably cooled to approximately 130° F. or less before contacting the trona powder to minimize any pre-calcination of the trona. Cooling of the compressed air is frequently accomplished with an air-to-air type heat exchanger. In some cases, the conveying air for unloading trona powder from PD trucks or PD railcars is also dried to reduce its moisture content. In the prior art, such drying systems are designed to reduce the moisture content of the conveying air to low levels, apparently in the belief that very low humidity gives the best protection to the trona. For example, U.S. patent application Ser. No. 12/378,830 (Ritzenthaler) suggests reducing the moisture in air prior to pneumatically conveying trona powder to a “relative humidity approximately equal to 0%, and an absolute humidity approximately equal to 0.02 grains of water per pound of dry air”. U.S. Pat. No. 8,383,071 (Dillon) states that the conveying air for sorbents (e.g., trona powder) should have “a relative humidity of no more than about 10%, more typically of no more than about 5%, and even more typically of no more than about 1%”. U.S. Pat. No. 8,215,575 (Palin) mentions treating air used in conveying sorbents, such as trona, in a sorbent milling process. In Palin, the air is subjected to a drying/chilling step before contacting the sorbent, but the humidity of the resultant conditioned air isn't stated. Atwall in a presentation titled “Sodium Sorbent for Dry Injection Control of SO₂ and SO₃” that was made at the Reinhold Air Pollution Control Conference in July 2009 noted that “conditioned air for (sorbent) unloading can be helpful but not required” and the “ideal relative humidity is below 40% for transfer to storage”. Davidson at the Energy, Utility & Environmental Conference in February 2011 in a presentation titled “Moisture & Trona: What is Really Important” stated that a temperature of less than 140° F. and a relative humidity of less than 40% is preferred for conveying trona powder. Davidson also presented results of flowability tests with trona powder that had been exposed to different levels of moisture ranging from 35% to 90% relative humidity, and those tests under simulated storage conditions showed flow properties declined as the relative humidity increased. None of the prior art suggests that too low a moisture content in the air used to convey trona powder may adversely affect the flow properties of the material. In fact, the primary consideration in deciding how low to drive the moisture content of the conveying air apparently has previously been the capital and operating costs for the dehumidification equipment as opposed to any impact that too low a moisture level might have on the trona powder flowability.

### SUMMARY OF THE INVENTION

In accordance with the present invention trona powder to be injected into a flue gas is pneumatically conveyed under controlled conditions wherein
a. the temperature of the conveying air is maintained at less than 135 degrees F.,
b. the relative humidity of the conveying air is maintained between about 15% and 50% and
c. the dew point of the conveying air is maintained above the temperature of both the conveying lines and the receiving vessels

### BRIEF DESCRIPTION OF THE FIGURES

FIG. 1 is a graph showing an example of the weight gained or lost from a sample of trona powder exposed to different levels of relative humidity at a temperature of 73° F.

FIG. 2 is a graph showing the relationships among blower pressure, blower outlet temperature and free moisture content of trona powder.

FIG. 3 is a graph of trona moisture pickup vs. relative humidity from four field tests.

FIGS. 4, 5, 6 and 7 are simplified block flow diagrams of several embodiments of the invention for conditioning the air used to pneumatically transport trona powder.

### DETAILED DESCRIPTION OF THE INVENTION

As used herein the following terms have the indicated meanings:

“Trona powder” refers to trona ore that has generally been processed to a mean particle size of approximately 100 microns or less and more generally to a mean particle size of 50 microns or less, and even more generally to a mean particle diameter of 35 microns or less. To produce trona powder, trona ore may be subjected to several different unit operations, such as screening, milling, air classification, beneficiation and drying. Trona powder is generally shipped in bulk PD railcars or trucks with a free moisture content of below 0.07%.

“Free moisture”, aka loss on drying, refers to the free moisture content of trona as determined by a desiccant based procedure developed by Natronx Technologies, LLC. This procedure entails equilibrating the sample to be analyzed to room temperature, placing a known weight of the sample (approximately 10 grams) on an aluminum pan that is placed in a sealed container with a 4 Angstrom molecular sieve (e.g., Sigma-Aldrich part number 20860-4 for 1 kg or equivalent). The sample is removed from the room temperature container after 45 minutes exposure to the desiccant and weighed. The percent weight loss is calculated and reported as free moisture (aka loss on drying).

“Bound water” refers to molecularly bound water in sodium sesquicarbonate or sodium carbonate hydrates.

“Conditioned air” refers to ambient air that has been subjected to certain unit operations prior to being used for pneumatically conveying trona powder. The unit operations typically consist of one or more of chilling/condensing, dehumidification with desiccants, compression, cooling and, in certain cases, humidification.

The present invention is a process for pneumatically conveying trona powder prior to dry sorbent injection of the trona powder into a flue gas to remove impurities in the flue gas resulting from the combustion of a fuel. The process involves transporting the trona powder from a container in which it is shipped through a conveying line to a receiving vessel by the use of conveying air. It has now been found that improved results are achieved when the following conditions are used:
(a) the temperature of the conveying air is less than 135° F.,
(b) the relative humidity of the conveying air is between about 15% and about 50%, and
(c) the dew point of the conveying air is maintained above the temperature of both the conveying line(s) and the receiving vessel(s).

It has unexpectedly been discovered that reducing the moisture content of the conveying air below certain levels can cause deterioration of trona powder flowability. Hence there is both an upper and lower limit on the desirable moisture level of the conveying air. At too high a humidity in the conveying air, trona will pick up moisture, and flow properties of the powder will be negatively impacted. At too low a humidity in the conveying air, trona may lose not only free moisture but also some of the molecularly bound water in the sodium sesquicarbonate. Any bound water that is released from the sodium sesquicarbonate is of particular concern. While the exact mechanisms are uncertain, and without wishing to be bound to any particular theory, the following reactions may occur to some extent when the air employed to pneumatically convey trona has a very low moisture content:

Na₂CO₃.NaHCO₃.2H₂O→⅓((NaHCO₃)₃.Na₂CO₃)+⅔Na₂CO₃+2H₂O (equation 2)

Unlike equation 1 above, this reaction does not result in decomposition of the sodium bicarbonate portion of the sodium sesquicarbonate molecule; hence there is no evolution of carbon dioxide.

Depending on temperature and other factors, the water and sodium carbonate produced from the foregoing reaction can then combine to form hydrates, such as:

Na₂CO₃+H₂O→Na₂CO₃.H₂O

Na₂CO₃+7H₂O→Na₂CO₃.7H₂O

Na₂CO₃+10H₂O→Na₂CO₃.10H₂O

Hydrates formed from the released molecular water and the generated anhydrous sodium carbonate from the low humidity decomposition of the sodium sesquicarbonate can lead to agglomeration, caking and material flow problems with the trona powder. Depending on the temperature, the hydrate can be sodium carbonate monohydrate, heptahydrate or decahydrate. Although the extent of partial decomposition of the sodium sesquicarbonate in low temperature (less than about 130° F.) and low humidity (less than about 15% relative humidity) conveying air may be small, the impact on the trona powder flow characteristics can be significant. The released molecular water transported as water vapor along with the trona powder into storage vessels may condense on cold surfaces in those vessels and ultimately cause lumps to form in the vessels and hinder material flow. The cohesiveness of these agglomerates increases with compressive forces as would typically be exhibited in storage silos or railcars filled with trona powder. The agglomerates may contain a higher moisture content than the bulk of the trona powder in the vessel such that only part of the powder may be free flowing until the growth and compaction of agglomerates effectively blocks the normal flow path of the free flowing powder discharging from PD trucks, silos, etc. Besides potentially creating material handling problems, agglomerate formation can reduce the efficacy of the trona powder in applications such as DSI. The effectiveness of the trona powder in most applications typically is related to the mean particle size and size distribution, therefore agglomeration of the trona particles themselves is disadvantageous independent of the flow characteristics.

Alternatively, some of the bound water evolved may become free moisture on the trona with a resultant unfavorable effect on the flow properties of the powder. For example, trona powder containing as little as about 0.07% free moisture typically exhibits reduced flowability. If just 0.5% of the trona powder decomposes per equation 2 during pneumatic conveying and all of the released bound water later uniformly rejoins the trona powder in the storage vessel, then the free moisture content of the trona powder would exceed the 0.07% level where trona powder flowability typically becomes more problematic.

As will be described, we have found that the relative humidity of the air used to pneumatically convey trona powder should preferably be conditioned to have a temperature of about 130° F. or less and a moisture content between about 30 to 75 grains water/lb dry air, preferably in the range of 30 to 50 grains water/lb dry air. These moisture contents correspond to a relative humidity range of 20 to 40%, preferably in the range of 20 to 30%. A further constraint is that the dew point of the conditioned air should be above the temperature of the conveying lines and also above the temperature of the receiving vessels to avoid condensation.

### Laboratory Scale Experiments

To explore the sensitivity of trona powder flowability to free moisture content, samples of trona powder containing 0.02% free moisture were humidified for various time periods in a 100% relative humidity chamber at 73° F. Care was taken to make certain no water condensed in the chamber, i.e. no liquid water contacted the trona samples. Samples were removed from the humidity chamber at different times and placed into bottles, rolled and shaken to homogenize the material, and analyzed for free moisture content. The bottles of moisturized trona were stored at room temperature for about one month during which time soft lumps formed in the bottles. Next the samples were placed on a 12 mesh screen (U.S. Sieve Series) that was gently shaken by hand to separate out fine material while keeping most of the lumps intact. The weight percent of material remaining on the 12 mesh sieve was calculated to quantify the degree of agglomeration as shown in Table 1.

TABLE 1
Trona Agglomeration vs. % Free Moisture

| Free Moisture | Agglomeration |
|---|---|
| wt. % | wt. % |
| 0.02 | 3 |
| 0.04 | 5 |
| 0.07 | 36 |
| 0.12 | 37 |
| 0.22 | 53 |

This laboratory experiment indicates that a significant increase in lump formation occurs between approximately 0.05% and 0.07% free moisture on trona powder. Field experience with handling trona powder has also shown that flow properties tend to deteriorate above approximately 0.07% free moisture. Therefore, a very small amount of moisture pickup can create problems in handling trona powder.

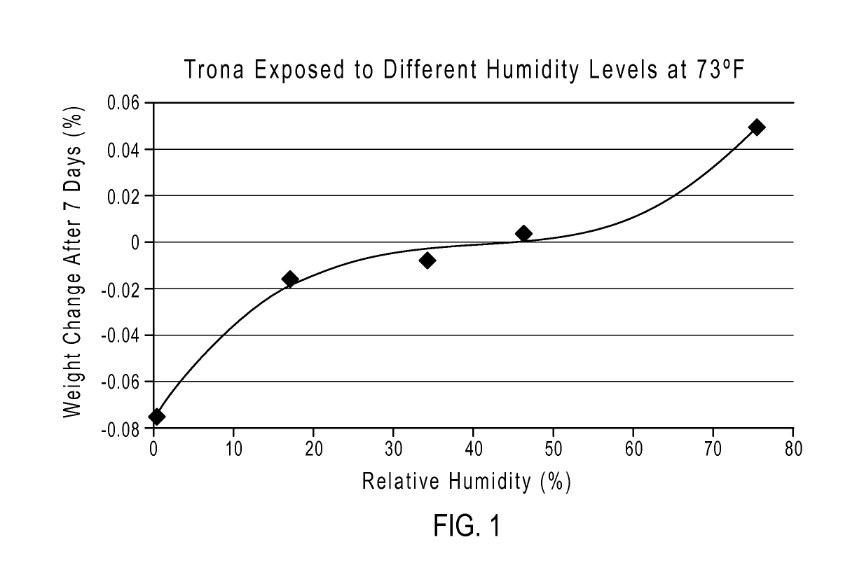

Experiments were also carried out to measure the weight change of trona powder samples exposed for seven days to different levels of relative humidity at room temperature, which was about 73° F. The trona powder used in these tests had an initial free moisture content of 0.02%. The results are plotted in FIG. 1. Between about 15% and 50% relative humidity, trona powder gained or lost a relatively minor amount of water. Although FIG. 1 provides results for only seven days of exposure, there was little additional gain or loss after one month for the samples in the 15% to 50% relative humidity range. At 75% relative humidity, trona powder gained significant weight in seven days but didn't pick up any more moisture after one month. Not shown in FIG. 1 are results for trona powder approaching 100% relative humidity where the sample gained 0.4% in weight after three hours and 2.2% after one day. FIG. 1 shows trona powder in a desiccated environment (about 0.4% relative humidity) at room temperature lost 0.08% in weight over seven days. After one month the loss for the desiccated sample had increased to 0.6% and hadn't reached steady-state. In the case of the desiccated sample, the moisture being removed was primarily molecularly bound water, apparently by the decomposition reaction described by equation 2. This work shows significant moisture pick up by trona powder can occur above about 50% relative humidity, and an undesirable release of molecular bound water from trona may be encountered below approximately 15% relative humidity.

### Full-Scale Trials

Field tests were performed to confirm the results seen in the laboratory experiments on the impact of humidity on the flowability of trona powder. These field tests were conducted over a several year period in a variety of ambient relative humidity conditions to further refine the optimum conveying air properties to avoid deterioration of trona powder flowability. PD railcar shipments of 100 tons of trona powder with a free moisture content in the range of 0.015% to 0.035% were used in these tests. Approximately 24 tons of trona powder was transferred to PD trucks, and the conveying air was controlled to a different humidity level for each truck.

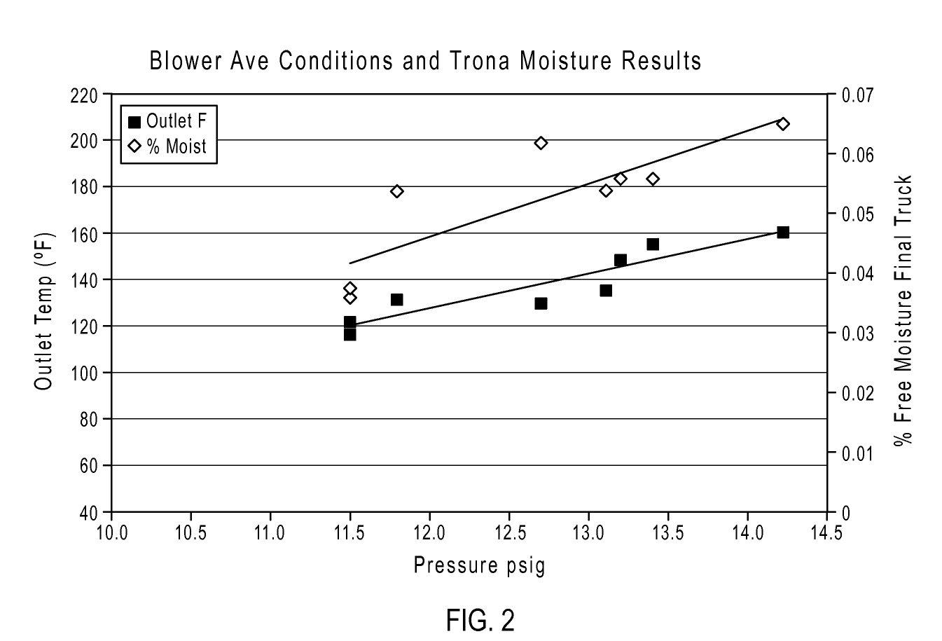

In the first series of tests no dehumidification equipment was available; trona powder was pneumatically transferred from PD rail cars to PD trucks while trona samples were drawn and blower conditions were controlled. As FIG. 2 illustrates the trona free moisture content increased as the blower temperature and pressure increased. This was a counterintuitive finding as the warmer air temperatures would ordinarily be expected to dry at least some of the free moisture present in the powdered trona. At first it was thought that since the moisture content of the air exiting the system was lower than the inlet air humidity, the trona moisture increased because of the absorption of moisture from the transport air. However further analysis concluded that this mechanism did not fully explain the observed change in trona moisture content. This change was ultimately explained by understanding the stepwise partial decomposition mechanism of the trona whereby the threshold energy supplied to the trona in the hot air stream was sufficient to release molecularly bound water according to equation 2 without a corresponding release of CO₂. Since trona has been found by some to exhibit poorer flow characteristics at free moisture levels above 0.04%, it was determined that the transport air temperature should be maintained below 130° F. to prevent a degradation of the trona product quality.

Further study revealed that trona exhibits an equilibrium relationship with the moisture content of the vapor above it. As the temperature of the system at equilibrium is increased, the water vapor pressure or partial pressure of water increases. Even though during the trona transfer process, equilibrium conditions may not be met, there exists a driving force for molecularly bound moisture to volatilize. This moisture transferred to the air stream begins to cool the air stream. The air stream is also cooled by the expansion of the air as the pressure drops during the deposition of the transferred trona from the PD rail car into the PD truck because the air pressure in the PD truck is much lower than in the PD rail car. The condensation mechanism as well as the natural attraction of trona powder to moisture combines to increase the free moisture content of the transferred trona. Both the inlet air humidity content and the air transport temperature were recognized as contributors to the rise in trona free moisture content.

In a second series of field tests, trona was again transferred from PD rail cars to PD trucks but in this case the conveying air was ambient air that was dried by a chiller-condenser system followed by a wheel-type desiccant dryer and then compressed by a blower and cooled prior to being supplied to the PD rail car. This conditioned air was used to transfer the trona powder to the PD trucks. Air leaving the trucks was cleaned in a baghouse dust collector before being exhausted to the atmosphere. For the first truck, the transport air supplied to the PD railcar was dried to a relative humidity of 9% and cooled to a temperature of 103° F. There was a significant change in the free moisture content of the trona powder during this trans-loading operation (PD truck sample was 0.008% higher in free moisture than the starting railcar trona, and that represented a 62% increase in free moisture content). Furthermore, the air exhausted from the PD truck loading baghouse had gained 11 grains water/lb dry air compared to the conveying air entering the PD railcar. Both the increase in trona free moisture content and the humidification of the transport air indicated bound water had been released during trans-loading.

For the second truck, the transfer air was dried to a relative humidity of 40% and cooled to 85° F. The trona powder gained a small amount of moisture (0.006% higher free moisture in the PD truck sample than in the PD railcar sample representing a 29% increase in trona free moisture content). The air leaving the PD truck baghouse showed a reduction of 8 grains water/lb dry air vs. the transport air entering the PD railcar. This implies that the trona absorbed a small amount of humidity from the air. Small changes in bound water can't be easily determined by analytical methods. Hence, if bound water were released due to equation 2 and then formed a hydrate, such as sodium carbonate decahydrate, the flow properties of the trona could decline without a significant change in the free moisture content of the trona powder.

As with the laboratory experiments and earlier field test results graphed in FIG. 2, it has been discovered that the transport air for trona powder should preferably be cooled to approximately 130° F. or lower and the relative humidity kept in the range of approximately 15% to 40% to minimize flowability problems with trona powder.

Table 2 below summarizes the first two field tests described above and also two additional tests. The third and fourth field tests listed in Table 2 were run with no dehumidification. The only treatment of the transport air was to cool the blower discharge. In the third test, the transport air entering the rail car had a relative humidity of 57%, and this level of moisture in the air resulted in a 70% increase in the free moisture content of the trona. The fourth test reported in Table 2 was conducted during a season of lower atmospheric relative humidity. With a relative humidity of just 21% in the air entering the railcar, the trona moisture pick-up was only 14%. This latter test result was optimal because it achieved a very low increase in trona moisture content.

TABLE 2
Additional Field Tests Involving Transfer of Powdered
Trona from PD Railcars into PD Trucks

| Test | Atmospheric | Air Temp | Relative | Trona moisture | Trona |
|---|---|---|---|---|---|
| Configuration/ | Relative | into railcar | Humidity into | incremental | moisture |
| Setup | Humidity (%) | (Deg F.) | railcar (%) | gain (%) | increase (%) |
| Full Dehumidification | 44 | 103 | 9 | 0.008 | 62% |
| Partial Dehumidication | 70 | 85 | 40 | 0.006 | 29% |
| Air Cooling Only | 61 | 92 | 57 | 0.011 | 70% |
| Air Cooling Only | 51 | 92 | 21 | 0.005 | 14% |

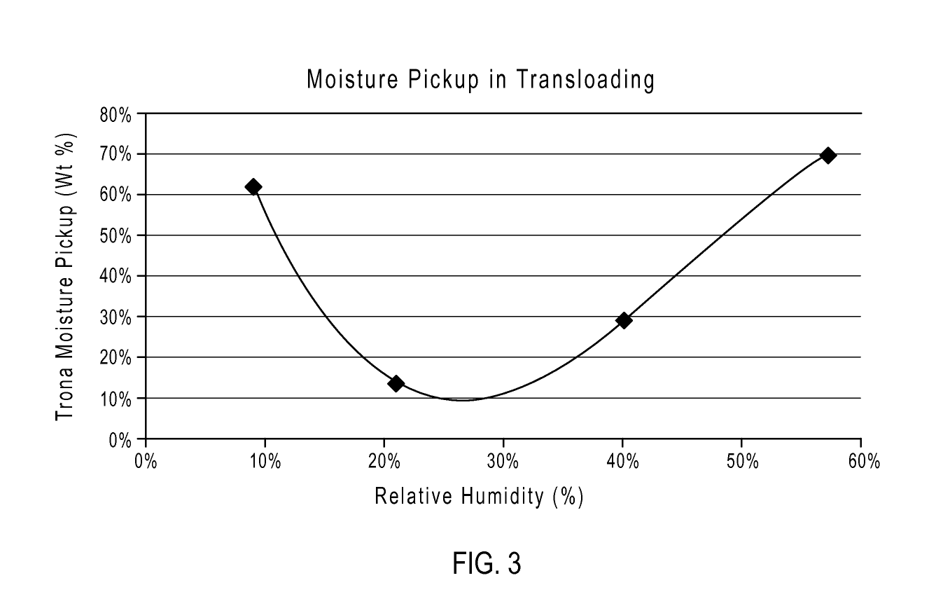

The results from the four field tests are plotted in FIG. 3 where trona moisture pick-up appears as a function of the relative humidity of the air entering the railcar. The graph shows moisture pickup by the trona goes through a minimum. The graph indicates that a relative humidity of approximately 25% would minimize moisture pick-up by the trona. As a practical matter, the flow properties of the trona powder shouldn't significantly deteriorate if the moisture pickup stays below about 30%. That corresponds to a relative humidity range of approximately 15% to 40%.

The field results complement the laboratory scale experiments that were described previously and shown in FIG. 1. FIG. 1 indicates there is little change in the trona moisture content until the relative humidity of the air either drops below about 15% or goes above approximately 50%. Again, this shows there is a range in which the humidity of the conveying air should be held to protect the trona powder.

It has been unexpectedly found that there is a lower limit on the relative humidity of the conveying air. This is completely different from the prior art. The prior art teaches there is only a maximum limit on humidity. It has now been found that there is also a lower limit, and that limit is approximately 15% relative humidity. Above about 40-50% relative humidity, trona powder can pick up significant free moisture. Below about 15-20% relative humidity, trona powder can lose molecular bound water.

Depending upon the atmospheric relative humidity at the time of pneumatic transport of the trona, no dehumidication of the transport air may be needed and thus only inexpensive air cooling may be sufficient to prevent deterioration of trona quality characteristics as demonstrated in the fourth test listed in Table 2. These tests are instructive in determining the range of transport air humidity levels which are necessary to maintain good flowability properties of the trona powder and minimize the potential for costly removal of trona agglomerates that may form in bulk storage vessels in common use. In addition, the desired limits for temperature, relative humidity and dew point of the air used for pneumatic transport of trona powder not only help prevent flowability problems with trona powder but also help maintain the efficacy of the trona powder when subsequently used in applications, such as DSI.

### System Description

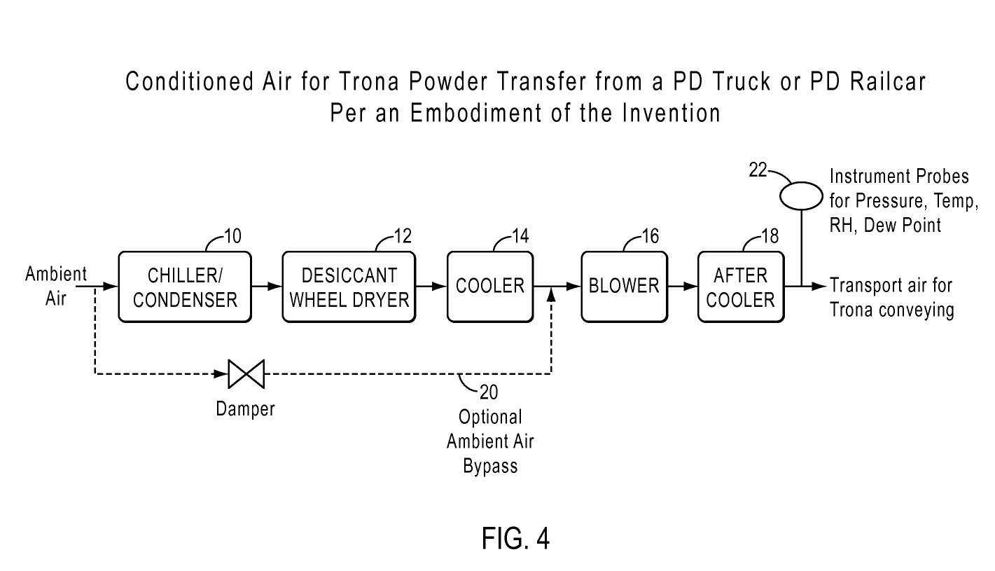

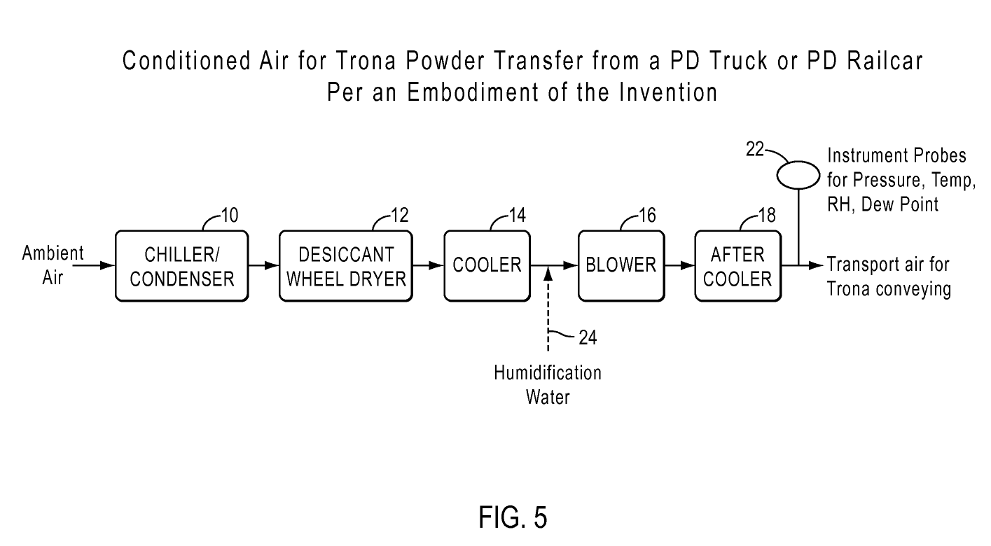

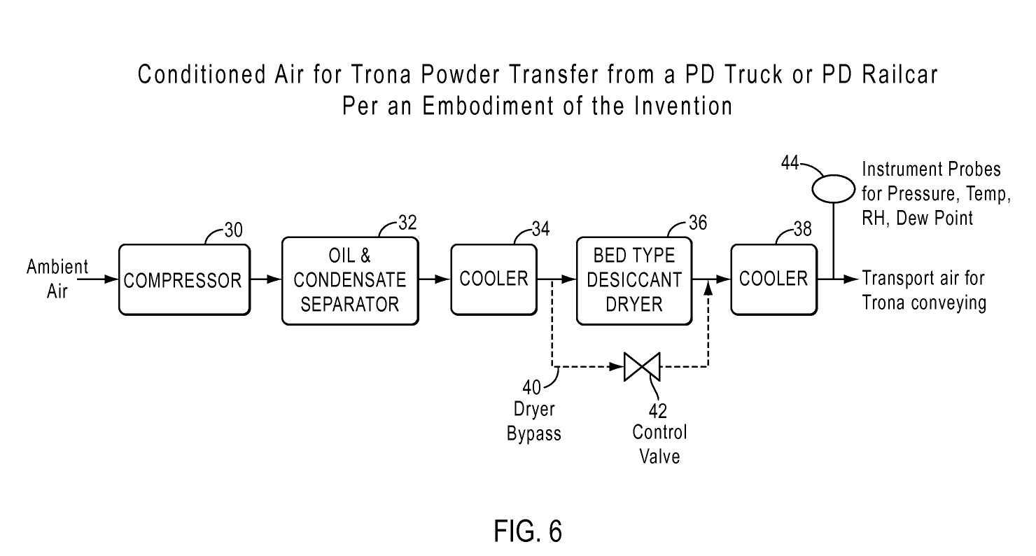

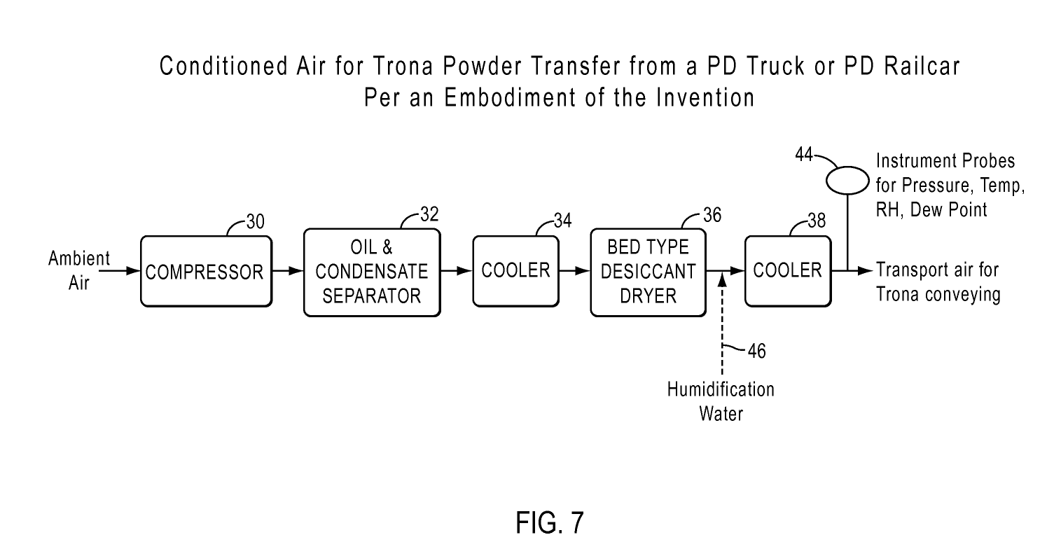

Various arrangements of air dryers, coolers and blowers or compressors can be used to condition the air used for transporting the trona powder. FIG. 4 shows one embodiment of the invention that employs a chiller/condenser combination [10] followed by a desiccant wheel type dryer [12] followed in turn by an optional cooler [14] ahead of a blower [16] or compressor and an after-cooler [18]. In order to supply transport air in the targeted humidity range, some moisture may have to be added to the air, particularly in very cold climates where the ambient humidity is less than the lower desired limit for the conditioned air. In FIG. 4, an optional ambient air bypass [20] around the condenser and desiccant dryer steps is included to raise the humidity, if necessary. On-line measurements [22] of the conditioned air properties, such as relative humidity (RH), temperature, pressure and/or dew point, can be used to either manually or automatically control the amount of air bypassed to achieve the desired relative humidity of the conditioned air. FIG. 5 shows an embodiment of the invention with the same general configuration as FIG. 4 except that humidification of the air, if necessary, is done by adding moisture to the dried air [24] using spray nozzles, such as air atomizing nozzles, to obtain very small water droplets or using steam for humidification. The amount of moisture added can be controlled, either manually or automatically based on measurements of the relative humidity, temperature, pressure and/or dew point of the transport air. FIG. 6 is another embodiment of the invention which uses a different configuration. Ambient air is first introduced to a compresser [30] followed by an oil and condensate separator [32] followed in turn by a cooler [34], a bed type dessicant dryer [36] and a second cooler [38]. Optionally, some air may be bypassed around the dryer [40] using a control valve [42] to either manually or automatically control the amount of air bypassed to achieve the desired relative humidity of the conditioned air. On-line measurements [44] are employed to monitor the conditioned air properties, such as relative humidity (RH), temperature, pressure and/or dew point. FIG. 7 has the same equipment arrangement as FIG. 6, but moisture can be optionally added [46] to increase the humidity, if necessary.

Standard instrument probes can be used to measure properties of the conveying air, such as pressure, dry bulb temperature and relative humidity. From those parameters, the dew point temperature and moisture content (e.g., grains water/lb dry air) can be calculated from standard equations or determined from a psychrometric chart. For example, Perry's Chemical Engineering Handbook, sixth edition, chapter 12 on “Psychrometry” contains psychrometric charts and equations for various humidity calculations including adjustments for pressures other than standard barometer. Similar determinations of the ambient air properties (e.g., temperature, moisture content, dew point, etc.) would preferably also be made. Hence an operator of a conditioned air system could monitor the properties of the ambient air and the conveying air and manually make adjustments to the system, such as adjusting the degree of bypass in the FIG. 3 configuration or the water addition in the FIG. 4 arrangement, to keep the conditioned air within the targeted limits, e.g. less than approximately 130° F. and approximately 15%-40% relative humidity. Alternatively, the system can be automated with the ambient air properties and conveying air properties continuously measured and adjustments automatically made in the amount of bypass air and water addition. To better monitor and control the conditioned air system, instruments can be installed to measure the flow rate of the various streams, such as the bypass air, etc. In some cases, the chiller/condenser and/or the desiccant dryer can be manually or automatically shut down depending on the moisture content of the ambient air. For example, if the ambient air contained less than about 50 grains water/lb dry air, then the cooler/condenser and desiccant dryer might not need to operate.

What is claimed is:

1. In a process for pneumatically conveying trona powder prior to dry sorbent injection of the trona powder into a flue gas to remove impurities in the flue gas resulting from the combustion of a fuel, said process comprising
a. transporting the trona powder from a container in which it is shipped through a conveying line to a receiving vessel by the use of conveying air
the improvement wherein:
the temperature of the conveying air is less than 135° F.,
the relative humidity of the conveying air is between about 15% and about 50%, and
the dew point of the conveying air is maintained above the temperature of both the conveying lines and the receiving vessels.

2. A process as in claim 1 wherein the relative humidity of the conveying air is between about 20% and about 40%.

3. A process as in claim 1 wherein the relative humidity of the conveying air is between about 20% and about 30%.

4. A process as in claim 1 wherein the temperature of the conveying air is about 130° F.

5. A process as in claim 1 wherein the trona powder is milled or pulverized after removal from the receiving vessel and prior to injection into the flue gas.
